(19) United States
(12) Patent Application Publication
(10) Pub. No.: US 2022/0129252 A1
(43) Pub. Date: Apr. 28, 2022

(54) Processing Unit, Software module, Methods and Program Codes

(71) Applicant: Intel Corporation, Santa Clara, CA (US)

(72) Inventors: Kamarul Zaman ABDUL RASHID, Bayan Lepas (MY); Tat Kin TAN, BAYAN LEPAS (MY)

(21) Appl. No.: 17/643,854

(22) Filed: Dec. 13, 2021

(51) Int. Cl. G06F 8/34; G06F 8/65; G06F 8/41; G06F 9/445

(52) U.S. Cl. CPC G06F 8/34; G06F 9/44526; G06F 8/433; G06F 8/65

(57) ABSTRACT

A processing unit is provided. The processing unit includes one or more interfaces configured to communicate with at least one hardware component and processing circuitry configured to control the one or more interfaces and to determine a superset of a plurality of hardware microservices of the at least one hardware component.

### BACKGROUND

Application software developers always struggle when it comes to provisioning and subsequently consuming a specific hardware microservice without writing their own or custom hardware abstraction layer or shim layer. For example, a hardware microservice which was built for dedicated operation often needs a gluing firmware and/or corresponding drivers to reveal the hardware microservice which later must be exposed and abstracted as API (application programming interface). A middle layer termed API (also referred as software microservice) may then be needed to allow the higher level of software application to tap into/access the hardware microservice.

The concept of modeling hardware microservices often existed in hardware engineering practice through simulation technologies and platforms. For example, from other systems are simulation platforms known, which are capable of performing system simulation on a complex hardware operation. These platforms are a full system simulator framework representation mimicking electronics hardware operation. However, these platforms are best deployed to support hardware simulation. There are other pockets of example tools that can offer hardware programming features visualization, but not a good solution for hardware microservice abstraction. For example, a programming language itself can be utilized which is not a tool and can provide visualization for software libraries abstraction simulation.

Both approaches lack of visualization capability for hardware abstraction. Further, they lack instantaneous feedback, and are short of immediate impersonation and are prone to human-influenced programming errors, because it is not a hardware abstraction or modeling tools. Thus, a user, e.g., an application developer needs to be given an opportunity or an abstraction solution where he can instantaneously simulate, or rapidly configure different conceptual representation of software.

For example, if a software developer wants to develop security sensitive application and may wish to use the hardware microservice as the hardware root of trust and therefore will have to carefully navigate between many firmware and software libraries in order to tap into the hardware microservice. Thus, there may be need to increase an accessibility/eligibility of hardware microservices.

### BRIEF DESCRIPTION OF THE FIGURES

Some examples of apparatuses and/or methods will be described in the following by way of example only, and with reference to the accompanying figures, in which

FIG. 1 shows a block diagram of an example of a processing unit;

FIG. 2 shows a block diagram of an example of a software module;

FIGS. 3a and 3b show an example of a universal IDE;

FIGS. 4a-4c show the IDE of FIG. 3 in more detail; and

FIG. 5 shows an example of a conceptual IDE meta modeling;

FIGS. 6a-6c show the conceptual IDE meta modeling of FIG. 5 in more detail;

FIG. 7 shows an example of a method for a software module;

FIG. 8 shows an example of a method for a processing unit; and

FIG. 9 shows a computing device.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

Some embodiments may have some, all, or none of the features described for other embodiments. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an embodiment,” “in embodiments,” “in some embodiments,” and/or “in various embodiments,” each of which may refer to one or more of the same or different embodiments. Furthermore, the terms “comprising,” “including,” “having,” and the like, as used with respect to embodiments of the present disclosure, are synonymous.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of the group A and B”. The same applies for combinations of more than 2 Elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

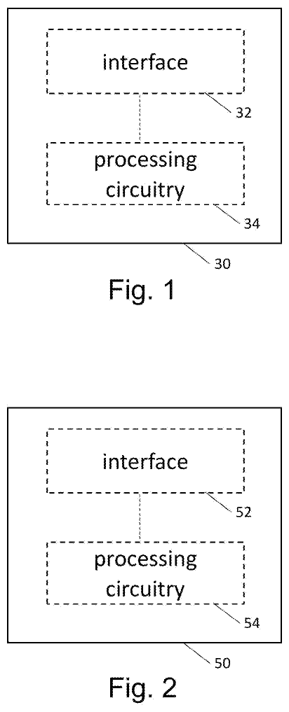

FIG. 1 shows a block diagram of an example of a processing unit 30. The processing unit 30 comprises one or more interfaces 32 configured to communicate with at least one hardware component and a processing circuitry 34 configured to control the one or more interfaces 32. Further, the processing circuitry 34 is configured to determine a superset of a plurality of hardware microservices of the at least one hardware component. Thus, the plurality of hardware microservices of the at least one hardware device can be summarized in the superset.

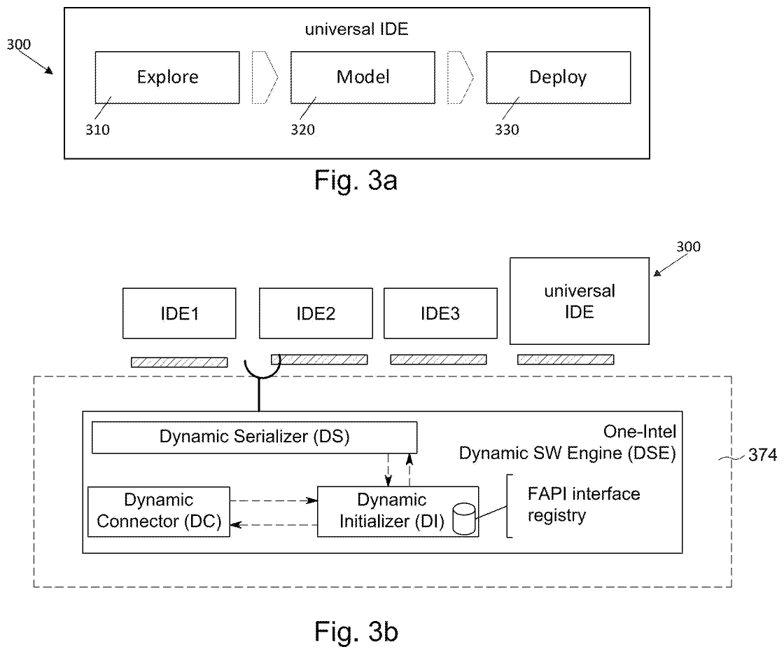

For example, the superset may comprise a collection (or catalog) of the plurality of hardware microservices of the at least one hardware component. This way, the superset can be used to provide information about the plurality of hardware microservices, e.g., to browse the plurality of hardware microservices. For example, the plurality of hardware microservices may comprise different hardware microservices (e.g., accessible by different integrated development environments; IDEs). Different hardware microservices may comprise different layers of configuration, or different sets of combined libraries such that different hardware microservices are accessible by different IDEs known from other system. Thus, a unique interface for using the plurality of hardware microservices can be provided by utilizing the superset, e.g., by incorporating the superset into an abstraction of a software microservice (see FIG. 2), herein referred as hardware API. For example, the plurality of hardware microservices can be accessed by the hardware API, e.g., to explore the plurality of hardware microservices to select a desired hardware microservice.

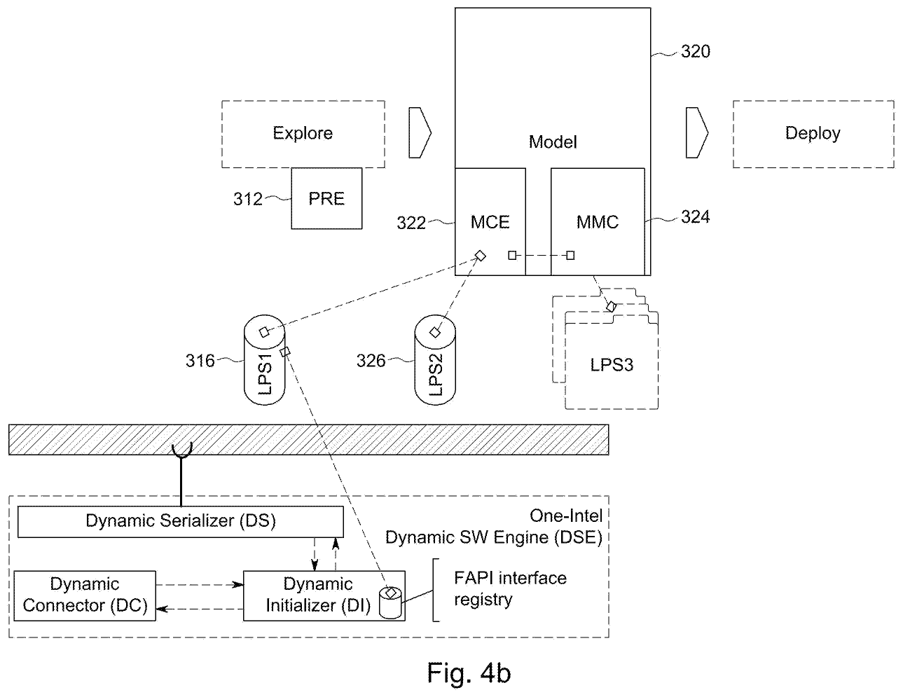

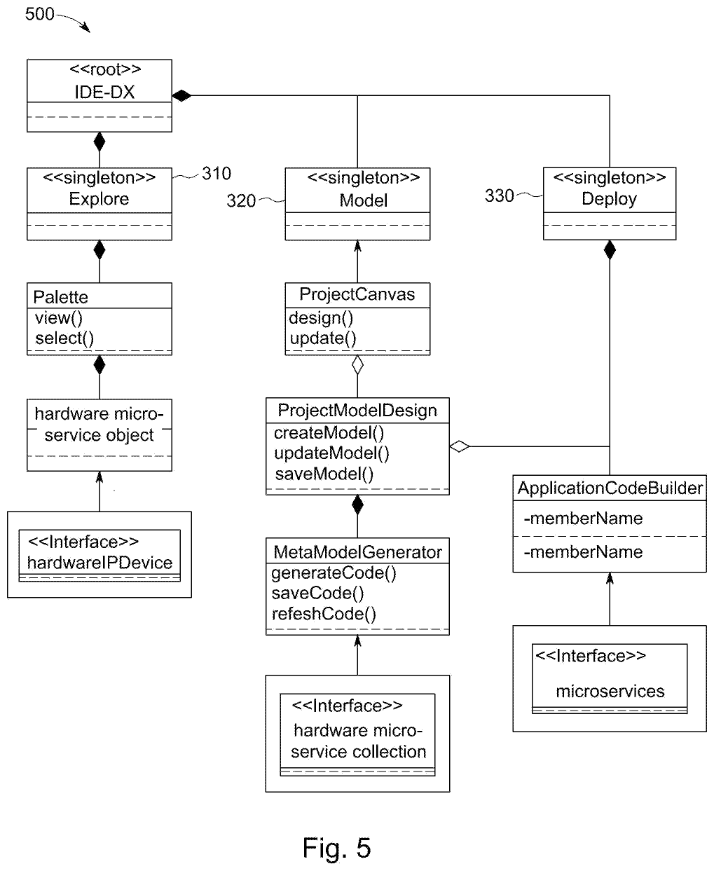

Further, by use of the hardware API immediate feedback can be provided to a user, for example. The superset can be used to generate the abstraction of the software microservice (the hardware API), providing low latency and ease of use, which may enable a user to explore (e.g., by an exploring process, see e.g., FIGS. 4a, 6a), model (e.g., by a modeling process, see e.g., FIGS. 4b, 6b) and deploy (e.g., by a deploying process, see e.g., FIGS. 4c, 6c) the plurality of hardware microservices, especially with an eased access and/or low entry cost. Thus, a conceptual software microservices design simulation method without a need of building into platforms known from other system can be provided. The hardware API may comprise a new software to hardware abstraction modelling platform with can be used to/perform catalog software microservice (explore), visual prototyping representation (model) and conceptual provisioning (deploy).

For example, the hardware API may provide a universal IDE modeling expression for a user, e.g., an application software developer (community), enhancing a user experience which is beyond coding, and containing the principal compounds of explore, model and deploy. This way, the hardware API may provide a visualized modeling apparatus of software microservices beyond coding.

To generate the hardware API the processing unit 30 is configured to determine the superset. The determination of the superset may be performed by determining the plurality of hardware microservices, e.g., all hardware microservices, of the at least one hardware component. The determined plurality of hardware microservices may be summarized in the superset, such that the superset comprises the plurality of hardware microservices (e.g., all hardware microservices) of the at least one hardware component. For example, a Local Persistent Storage attached to a Synchronization Engine to maintain latest copy of the hardware features abstraction catalog with its corresponding hardware API execution recipe post synchronization with the federated-registry in a cloud may be used. The Synchronization Engine may be a background process to periodically check for updates in an abstraction catalogue and execution recipes and subsequently update the Local Persistent Storage in the event of changes since the last update. The Local Persistent Storage may also capture a final hardware microservices selection. The Local Persistent Storage and the Synchronization Engine are described with more detail in FIG. 4.

In an example, the processing circuitry 34 may be further configured to generate a list comprising the plurality of hardware microservices. For example, the list can be a catalog of the plurality of hardware microservices. The plurality of hardware microservices may be sorted in the list to provide an eased access to a desired hardware microservices. For example, the plurality of hardware microservices may be sorted by name, a belonging hardware component, a functionality/feature, etc. Optionally, the list may comprise a plurality of sub-lists, such that each sub-list may comprise the hardware microservices belonging to a special functionality/feature, e.g., for random number generation. By generating a list/sub-list a post processing of the plurality of hardware microservices may be eased, e.g., a user may receive a desired sub-list.

In an example, the processing circuitry 34 may be further configured to observe a status (e.g., a characteristic, an attribute, etc.) of the at least one hardware component and if the status of the at least one hardware component has changed to redetermine a hardware microservice of the at least one hardware component. For example, a hardware microservice may have been updated, disabled, enabled, etc. and thus the plurality of hardware microservices may have changed, e.g., a feature/functionality of a hardware microservice of the plurality of hardware microservices may have changed. Thus, by observing the status of the at least one hardware component the plurality of hardware microservices can be kept actual.

The processing unit may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system. The hardware component may be a computer, processor, control unit, (field) programmable logic array ((F)PLA), (field) programmable gate array ((F)PGA), graphics processor unit (GPU), application-specific integrated circuit (ASICs), integrated circuits (IC) or system-on-a-chip (SoCs) system.

As shown in FIG. 1 the respective one or more interfaces 32 are coupled to the respective processing circuitry 34 at the processing unit 30. In examples the processing circuitry 34 may be implemented using one or more processing units, one or more processing devices, any means for processing, such as a processor, a computer or a programmable hardware component being operable with accordingly adapted software. Similar, the described functions of the processing circuitry 34 may as well be implemented in software, which is then executed on one or more programmable hardware components. Such hardware components may comprise a general-purpose processor, a Digital Signal Processor (DSP), a micro-controller, etc. The processing circuitry 34 is capable of controlling the one or more interfaces 32, so that any data transfer that occurs over the one or more interfaces 32 and/or any interaction in which the one or more interfaces 32 may be involved may be controlled by the processing circuitry 34.

In an embodiment the processing unit 30 may comprise a memory and at least one processing circuitry 34 operably coupled to the memory and configured to perform the below mentioned method.

In examples the one or more interfaces 32 may correspond to any means for obtaining, receiving, transmitting or providing analog or digital signals or information, e.g., any connector, contact, pin, register, input port, output port, conductor, lane, etc. which allows providing or obtaining a signal or information. The one or more interfaces 32 may be wireless or wireline and it may be configured to communicate, e.g., transmit or receive signals, information with further internal or external components. The one or more interfaces 32 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described below. The example shown in FIG. 1 may comprise one or more optional additional features corresponding to one or more aspects mentioned in connection with the proposed concept or one or more examples described below (e.g., FIG. 2-9).

FIG. 2 shows a block diagram of an example of a software module 50. The software module 50 comprises one or more interfaces 52 configured to communicate with a processing unit (e.g., the processing unit as described with reference to FIG. 1) and processing circuitry 54 configured to control the one or more interfaces 52. Further, the processing circuitry 54 is configured to receive information about a superset (e.g., the superset as generated by the processing unit described with reference to FIG. 1) of a plurality of hardware microservices of the at least one hardware component. Further, the processing circuitry 54 is configured to provide information about the superset and to generate a subset based on a user input. Thus, a user may be enabled to select a desired hardware microservice by use of the hardware API.

By providing the information a user may be given a capability to preview which hardware microservice he may need/can access to build/include into a model. Thus, a full and complete understanding of the underlying plurality of hardware microservices in order to build a relevant abstraction layer themselves can be provided to the user. Further, a need to recompile layers of a source code and stitching all the layers can be omitted, an easy access to software layers or libraries can be provided, a needing to resolve software compilation dependencies and to deal with compilation errors can be omitted, or a selection of a hardware microservice can be performed without knowledge about (multiple) coding language(s) especially for low-level languages.

By providing information about the superset a concept of modeling, designing and/or provisioning the plurality of hardware microservice can be provided. For example, the modeling can be performed by the user input, e.g., a(n action) user gesture. A depiction of the superset (e.g., on a display of a laptop, tablet, monitor etc.) may enable the user to select a desired hardware microservice of the plurality of hardware microservices. Thus, the user input can be a selection of a desired hardware microservice (e.g., received by a keyboard, touchpad, touchscreen etc.), which can be received in an exploring process, for example.

For example, the user input can be provided via an action gesture of movement (such as drag-and-drop, flip, swipe, swing, slide, grab etc.). By use/interpret the user input the software module 50 can instantiate a software object, especially between different software workspaces of an IDE, or a programming tool. Further, the software module 50 may be capable to trans-late/transform the user input, e.g., the action gesture (e.g., a drag-and-drop) into a codebase that can be compiled into an executable binary.

In an example, provide information about the superset and generate a subset may be comprised (or performed) by an exploring process. The exploring process can be one process of a plurality of processes, which can be performed by the software module 50. The plurality of processes may define a foundation or a fundamental for an abstraction of the plurality of hardware microservices into software microservices, e.g., by use of the hardware API. The hardware API may be based on the principles of low-code platform principles, which may emphasize a rich user experience. Further, coding effort to design, provision, and/or consume the plurality of hardware microservices can be reduced.

The plurality of processes (and its underlying hardware API design and attributes) may define an improved way to design an abstraction of the plurality of hardware microservices and/or to provision software microservices. For example, the exploring process may be used by a user to browse, peruse and/or explore the superset, e.g., a (master) catalog (e.g., the master catalog may comprise the list/sub-lists generated by the processing unit as described with reference to FIG. 1) of the plurality of hardware microservices and/or its underlying hardware API execution recipe(s).

In an example, the processing circuitry 54 may be further configured to check if an update of the received information is available and if the received information has been updated receive updated information about the plurality of hardware microservices. This way, the software module 50 can ensure, that a used superset, e.g., for the exploring process, is actual. For example, a currentness of the plurality of hardware microservices can be maintained.

In an example, the processing circuitry 54 may be further configured to synchronize the plurality of hardware microservices to provide them to an external processing unit. This way, the superset can be shared between processing units. For example, the external processing unit may be a remote terminal, which access the plurality of hardware microservices of a host terminal (e.g., the processing unit).

In an example, if a plurality of hardware microservice of the plurality of hardware microservices is selected the processing circuitry 54 may be further configured to generate a query plan for the plurality of hardware microservice. This way, an order of processing a plurality of desired hardware microservices can be generated. For example, a user may have chosen a plurality of desired hardware microservices in the exploring process and this chosen plurality of hardware microservices can be ordered in a necessary order. For example, a first chosen hardware microservice may generate an output parameter which may be needed as input parameter for a second chosen hardware microservice. Thus, in the query plan the first chosen hardware microservice would be located such that it is performed/processed before the second chosen hardware microservice.

For example, during the exploring process a selection of a hardware microservice may depend on a required input parameter of a hardware microservice. For example, a selection of a second hardware microservice, which requires as an input parameter an output of a first hardware microservice, can only be enabled if the first hardware microservice was selected by the user input. This way, the exploring process/query plan ensure that all chosen hardware microservices of the plurality of hardware microservice can be processed/executed, which may increase a user experience.

For example, a depiction of the superset may be a visual prototyping or modelling of final design implementation based on low-code platform principles where a user, e.g., an application developer, may build an end user experience right from the start, using the user input, e.g., an action gesture (e.g., drag-and-drop).

In an example, the processing circuitry 54 may be further configured to render the query plan of the plurality of hardware microservices into a hierarchical tree, e.g., a query result. For example, the hierarchical tree may comprise an order of processing the selected hardware microservices. For example, the hierarchical tree may reflect an execution order of multiple hardware microservices, e.g., a first hardware microservice, which provides an input for a second hardware microservice, must be executed first. This way, the user can be informed about a needed hardware microservice, which he may has to choose to achieve an execution of a desired hardware microservice, e.g., a user may have to select the first hardware microservice before he can select the second hardware microservice.

In an example, the processing circuitry 54 may be further configured to generate a sequence flow of the plurality of hardware microservices. The sequence flow may comprise the order obtained by the hierarchical tree, for example. For example, the sequence flow may comprise a codebase that can be compiled into an executable binary and/or an underlying hardware API execution recipe for executing the selected plurality of hardware microservice of the plurality of hardware microservices. This way, the sequence flow may provide information required to access/execute a feature/functionality of the plurality of hardware microservices.

In an example, generate the sequence flow may be comprised (or performed) by a modeling process. For example, the modeling process may belong to the plurality of processes which may define the foundation or the fundamental for an abstraction of the plurality of hardware microservices into software microservices, e.g., by use of the hardware API.

In an example, the processing circuitry 54 may be further configured to check if an output parameter of a first hardware microservice of the plurality of hardware microservices in the sequence flow matches an input parameter of a second hardware microservice of the plurality of hardware microservices in the sequence flow. This way, it can be ensured that the second hardware microservice can be executed, e.g., if the output parameter provided by the first hardware microservice is needed as input parameter for the second hardware microservice. For example, during the modeling process (and the exploring process) a user input may lead to a selection of the second hardware microservice without selecting the first hardware microservice. Thus, the first hardware microservice may be selected automatically by the software module 50 to ensure that all needed input parameters for the second hardware microservice are accessible. Optionally or alternatively, if the software module 50 recognizes that the output parameter of the first hardware microservice does not match (or is missing) the input parameter of the second hardware microservice the software module may provide again the information about the superset, e.g., to receive a new user input while a new explore process, to generate a new subset, e.g., based on the new user input. This way, it can be ensured that the user has selected all hardware microservice needed for generating/executing the sequence flow.

In an example, the processing circuitry 54 may be further configured to generate an agnostic code from the sequence flow. This way, different IDEs known from other system can process/execute the sequence flow by use of the agnostic code. Thus, a universal, unique access to the plurality of hardware microservices can be provided for different IDEs. For example, the agnostic code may comprise a specific execution recipe to execute the selected plurality of hardware microservices, which may have been selected in the exploring process by the user input and/or may have been proven for consistency in the modeling process.

In an example, the processing circuitry 54 may be further configured to transmit the agnostic code to an external processing unit to enable the external processing to use the plurality of hardware microservices. This way, the agnostic code can be shared between processing units. For example, a user may generate an agnostic code (using the exploring process and/or the modeling process) and may want to share this agnostic code with a further user, e.g., at a different location. Thus, the agnostic code can be used to store/share a model, e.g., comprising a selection of hardware microservices of the plurality of hardware microservices and an underlying hardware API execution recipe. This way, a collaboration between different users can be improved, since the agnostic code can build a foundation for data exchange, especially independently of a used software, e.g., an IDE. Thus, every IDE known from other systems can be able to accept an input resulting from the agnostic code.

In an example, the processing circuitry 54 may be further configured to decode the agnostic code to an application code. An application code (type) may be a code (type) used for IDEs known from other systems, e.g., Java, .Net etc. Thus, the information stored in the agnostic code can be accessed by every IDE, e.g., the universal IDE may be not needed. For example, a user may define a desired application code type for decode the agnostic code.

In an example, decode the agnostic code may be comprised (or performed) by a deploying process. For example, the deploying process may belong to the plurality of processes which may define the foundation or the fundamental for an abstraction of the plurality of hardware microservices into software microservices, e.g., by use of the hardware API. For example, the deploying process may convert a sequence flow, e.g., a finalized model (e.g., a visual model), into an application code, which can be used as base for a final deployment format. Further, the deploying process may comprise maintaining a development environment agnostic representation of the model.

For example, the plurality of processes (exploring process, modeling process, deploying process) may enable a user to browse through the superset (e.g., a catalog of the plurality of hardware microservices), to select desired hardware microservices, may provide a software structural modeling capability or may provide an automatic formulating of a source code (e.g., the agnostic code).

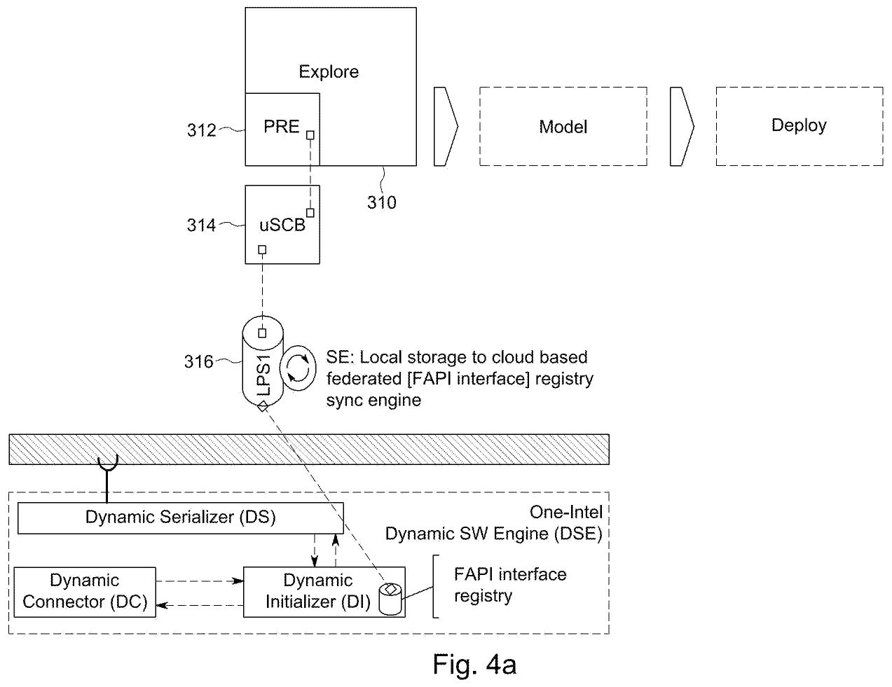

The plurality of processes can be considered as a universal IDE configured to access the plurality of hardware microservices of the hardware component and to provide a user all feature of IDEs known from the art. By use of the universal IDE a user may be enabled to produce a readily made software source code (the agnostic code) without a need to write a source code, which may increase a user experience. For example, a user may use a dragging collection of objects such as software libraries as a visualizable arts in the exploring process. Further, the user may perform a modeling based on a pool of software microservices (by use of the hardware API), which can be easily done by the universal IDE. The universal IDE may be capable to produce an executable binary and/or an underlying hardware API execution recipe as described with respect to the deploying process. The universal IDE is described in more detail below, e.g., with reference to FIGS. 3 and 4.

As shown in FIG. 2 the respective one or more interfaces 52 are coupled to the respective processing circuitry 54 at the software module 50. In examples the processing circuitry 54 may be implemented using one or more processing units, one or more processing devices, any means for processing, such as a processor, a computer or a programmable hardware component being operable with accordingly adapted software. Similar, the described functions of the processing circuitry 54 may as well be implemented in software, which is then executed on one or more programmable hardware components. Such hardware components may comprise a general-purpose processor, a Digital Signal Processor (DSP), a micro-controller, etc. The processing circuitry 54 is capable of controlling the one or more interfaces 52, so that any data transfer that occurs over the one or more interfaces 52 and/or any interaction in which the one or more interfaces 52 may be involved may be controlled by the processing circuitry 54.

In an embodiment the software module 50 may comprise a memory and at least one processing circuitry 54 operably coupled to the memory and configured to perform the below mentioned method.

In examples the one or more interfaces 52 may correspond to any means for obtaining, receiving, transmitting or providing analog or digital signals or information, e.g., any connector, contact, pin, register, input port, output port, conductor, lane, etc. which allows providing or obtaining a signal or information. The one or more interfaces 52 may be wireless or wireline and it may be configured to communicate, e.g., transmit or receive signals, information with further internal or external components. The one or more interfaces 52 may comprise further components to enable communication between vehicles. Such components may include transceiver (transmitter and/or receiver) components, such as one or more Low-Noise Amplifiers (LNAs), one or more Power-Amplifiers (PAs), one or more duplexers, one or more diplexers, one or more filters or filter circuitry, one or more converters, one or more mixers, accordingly adapted radio frequency components, etc.

More details and aspects are mentioned in connection with the examples described above and/or below. The example shown in FIG. 2 may comprise one or more optional additional features corresponding to one or more aspects mentioned in connection with the proposed concept or one or more examples described above (e.g., FIG. 1) and/or below (e.g., FIG. 3-9).

FIGS. 3a and 3b show an example of a universal IDE 300. As can be seen in FIG. 3a the universal IDE 300 comprises a plurality of processes 310, 320, 330. The IDE 300 comprises a ubiquitous concept for abstracting the plurality of hardware microservices of a hardware component, e.g., by use of a superset as described with reference to FIG. 1, which can be utilized by a software module described with reference to FIG. 2. As can be seen from FIG. 3a the universal IDE 300 may comprise three processes which may be performed from left to right, the exploring process 310, also referred as explore, the modeling process 320, also referred as model and the deploying process 330, also referred as deploy. Thus, the universal IDE 300 may distinctively recognize the process or methodology to craft (explore), compose, design implement (model) and/or widely provision (deploy) hardware/software microservices in a scalable fashion, e.g., on the base of the hardware API.

As can be seen from FIG. 3b, the universal IDE 300 may be an alternative for IDEs known from other system, which may have no access to each hardware microservice of the plurality of hardware microservices of a hardware component. Thus, the universal IDE 300 can improve a user experience. For example, the universal IDE 300 may introduce an innovative, unique and groundbreaking way for a user, e.g., an application developer to design, develop, and/or provision the plurality of hardware microservices of a hardware component in a seamless and/or scalable approach for end-user application development space. An underlying concept of methods and/or apparatus to expose a microservice to a software layer 374 as described in U.S. patent application Ser. No. 17/485,351 ([1]) may be used. The subject matter of U.S. patent application Ser. No. 17/485,351 is herewith expressly incorporated by reference into the present application.

More details and aspects are mentioned in connection with the examples described above and/or below. The example shown in FIG. 3 may comprise one or more optional additional features corresponding to one or more aspects mentioned in connection with the proposed concept or one or more examples described above (e.g., FIGS. 1-2) and/or below (e.g., FIG. 4-9).

FIGS. 4a-4c show the IDE the IDE of FIG. 3 in more detail. FIG. 4a shows an example of an architecture of the explore 310, which may comprise three sub-components 312, 314, 316, namely a palette rendering engine 312 (PRE), a microservices catalog builder 314 (μSCB) and a localized persistent storage 316 (LPS(n)).

A functionality of each sub-component 312, 314, 316 can be described as follow:
The PRE 312 may process and convert/render a raw machine-readable output from the μSCB 314 into a hierarchical tree representation to ease a selection by the user. This may allow a user, e.g., an application developer to browse, to select or eventually to decide on the (final) hardware microservices.
The μSCB 314 may be triggered as a query engine (e.g., a background process) which may receive a query request from the PRE 312 and subsequently build a hardware microservices catalog query plan and return the result, e.g., an output of the query plan, from the LPS1 316 to the PRE 312 as an input.
The LPS1 316 may be attached to a synchronization engine (SE) to maintain a latest copy of the hardware microservices abstraction catalog, e.g., the hardware API, with its corresponding hardware API execution recipe, e.g., post synchronization with a federated registry in a cloud. The SE (e.g., a local storage cloud based federated (femtocell application programming interface) registry) may be a background process to periodically check for updates in the hardware microservices abstraction catalogue (e.g., as described with reference to FIG. 2 the update for the received information) and an execution recipe and subsequently update the LPS1 316 in an event of a change since a last update. The LPS1 316 may also capture a final hardware microservices selection.

An exemplary workflow can be as follow. When Explore 310 is triggered, information about the superset may be provided, e.g., by use of a explore palette, to a user, e.g., an application developer. The PRE 312 may instantiate and trigger the μSCB 314 to validate if the latest version of the hardware microservices abstraction catalog is present. If the MSCB 314 may detect that the latest version of the hardware microservice abstraction catalog is not present, e.g., no version of the hardware microservice is present, further measures may be performed, for example the latest hardware microservice catalog may be loaded by connecting to the LSP1 316. In the event that the hardware microservices abstraction catalog is expired or deprecated, the μSCB 314 may connect with LPS1 316 to initiate a fresh download to synchronize the latest hardware microservices abstraction catalog (registry). The PRE 312 may then render the hardware microservices abstraction catalog in a format of hierarchical tree that can be expanded or collapsed, such that a user, e.g., a developer, may have an option to select (and build) a collection of hardware microservices of the superset to generate the subset in a canvas (e.g., a user-friendly representation on a display) represented as class type object.

FIG. 4b shows an example of an architecture of the model 320, which may comprise two subcomponents 322, 324, namely a modelling canvas engine 322 (MCE) and a meta model constructor 324 (MMC).

A functionality of each sub-component 322, 324 can be described as follow:
The MCE 322 may retrieve a final hardware microservice collection from the LPS1 316 and may render or paint a subset on a modelling canvas (e.g., a user-friendly representation on a display). Thereon, it may capture and document a user's decision(s) in setting a relationship, the choreography or the execution flow of the selected libraries plus the final execution recipe with optional embedded script and/or code.
The MMC 324 may be a form of an interpretation engine that convert the modelling from the MCE 322 stored in LPS2 326 into an agnostic machine-readable representation. The MMC 324 may assemble an agnostic model of software representation of MCE 322.
The LPS2 326 may be a persistent storage medium to permanently (and securely) store a machine-readable representation which can reproduced and/or non-repudiated.
The LPS3 328 (compare also FIG. 4c) may be a persistent storage medium for the final non-repudiable machine-readable platform agnostic hardware microservices design representation, e.g., the agnostic code generated by the software module (e.g., see FIG. 2).

An exemplary workflow can be as follow. When the model 320 is activated by a user action, the MCE 322 may first retrieve the collection of microservices selected from the explore 310, e.g., the subset generated based on the user input, which may be persisted in LPS1 316. Further, the MCE 322 may construct or paint the subset on a design canvas. Each user input, e.g., a gesture action that is either to associate between hardware microservices or distill each hardware microservice with custom codes or scripts, may be translated real-time into a machine-readable format and stored onto the LPS2 326. When the subset generated based on the user input (e.g., comprising selected hardware microservices, a desired order, etc.) may be passed to the MMC 324, a permanent and non-repudiable platform agnostic machine-readable representation of the final model, e.g., the agnostic code, may be generated and stored in LPS3 328.

FIG. 4c shows an example of an architecture of the deploy 330, which may comprise two subcomponents 332, 334, namely a code provisioning engine 332 (CPE) and an application code builder 334 (ACB).

A functionality of each sub-component 332, 334 can be described as follow:
The CPE 332 may be a core functionality of this component and may be to read and/or decode the machine-readable representation of the final model in LPS3 328 and prepare the cache to create a final implementation in the format of an application code, e.g., based on a user selection of an application code type, e.g., Java, .Net etc.
The ACB 334 may receive the handle or instruction to generate the final implementation in the format of an application code, e.g., based on a type of a code opted by a user, e.g., an application developer.

An exemplary workflow can be as follow. When the Deploy 330 is triggered by a user input, e.g., a gesture action, the CPE 332 may ingest and decode a machine-readable representation of the final model and send instruction or handle to ACB 334 to assemble the application software application code. The software application codes may then be provisioned onto the user specific IDE coding space for the user to consume the code.

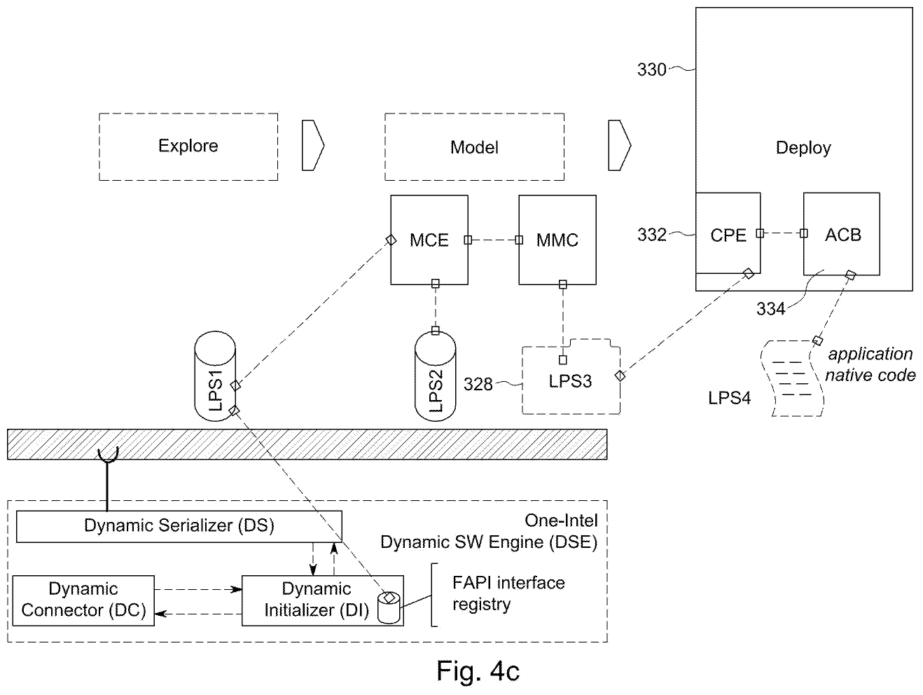

More details and aspects are mentioned in connection with the examples described above and/or below. The example shown in FIG. 4 may comprise one or more optional additional features corresponding to one or more aspects mentioned in connection with the proposed concept or one or more examples described above (e.g., FIGS. 1-3) and/or below (e.g., FIG. 5-9).

FIG. 5 shows an example of a conceptual IDE meta modeling 500. The conceptual IDE meta modeling 500 outlines a logical design in the form of a meta-model diagram and a corresponding sequencing of the plurality of processes, the explore 310, the model 320 and the deploy 330. Further, FIG. 5 also describe high level attributes for each process 310, 320, 330.

For example, in a high-level structural illustration a conceptualized platform (e.g., an IDE) may start as a root (IDE DX), which may comprise an exploration palette (explore 310), e.g., to generate the subset based on a user input provided by of the exploration palette which may provide visual information about the superset, a project canvas (model 320), e.g., to generate a codebase (based on a sequence flow) that can be compiled into an executable binary and/or an underlying hardware API execution recipe and a metaCodeGenerator (Deploy 330) to decode the codebase to an application code such that a specific IDE can access/use the selected hardware microservices.

More details and aspects are mentioned in connection with the examples described above and/or below. The example shown in FIG. 5 may comprise one or more optional additional features corresponding to one or more aspects mentioned in connection with the proposed concept or one or more examples described above (e.g., FIGS. 1-4) and/or below (e.g., FIG. 6-9).

FIGS. 6a-6c show the conceptual IDE meta modeling of FIG. 5 in more detail. FIG. 6a shows an example of an exploring process 310 (explore). The explore 310 may provide a capability to discover, browse and/or apply a selection of a hardware microservice of the plurality of hardware microservices comprised by the superset. The explore 310 may allow a user (e.g., a developer) to survey and/or browse for available hardware microservices (e.g., each hardware microservice of the hardware component), e.g., by the provided information about the superset, e.g., with an associated component/hardware microservice and/or a corresponding user defined libraries. A list of available hardware microservices features (e.g., the list generated by the processing unit as described with reference to FIG. 1) may be offered through a container 352, e.g., a Palette 352. The Palette 352 may be a mandatory concept of the explore capability and may act as a container to catalog available hardware microservices for a user to select and/or consume.

For example, an action of the user to pick and select hardware microservices objects (a hardware microservice) from the Palette 352 may comprise (but not limited to) two actionable properties a view service and a select service. The hardware microservices object 354 may comprise lists, sub-list, etc. of the superset. The knowledge about the plurality of hardware microservice may be essentially an ability to browse a catalog of all hardware microservices of the hardware component with a software microservice pre-aligned.

FIG. 6a further shows the relationship of the Palette 352 as a catalog to offer available hardware microservices with associated hardware microservice abstraction definition, an underlying implementation and an object labelled as hardware microservice object 354.

FIG. 6b shows an example of a modeling process 320 (model), especially a visualized modeling via a conceptual project canvas or a visual designer capability. The vision may be for a user, e.g., a developer, to model an application/model with desired hardware microservices and to interoperate these components with an external component and/or a user-defined libraries developed in various programming languages known form other systems. This way, developing an application may be like orchestrating existing components with hardware microservices of a hardware component together.

FIG. 6b shows a design property needed for a conceptual ProjectCanvas 362. The concept of developing an application using a ProjectCanvas 362 is commonly known as visual programming where a user uses gestures such as drag-and-drop programming building blocks from a list or Palette 352 shown in FIG. 6a.

The ProjectCanvas 362 may serve a purpose of presenting a template of software microservices based on what a user had discovered or selected in the explore 310. The ProjectModelDesign 364 may contain capability for a model to comprise (but not limited to) to create, update and/or save into a storage (e.g., the LPS2, LPS3). The model 320 may also comprise a capability to allow a user to navigate and/or update the design. The ProjectCanvas 362 may be an abstraction of the individual implementation of each user, such like developer or designer, and not a mandatory a definition of the model 320. For example, the ProjectCanvas 362 may be an individual workspace unique for each project implementation.

The ProjectModelDesign 364 may be a final design version or output of the user, such as like developer or designer, work products from the work applied on the ProjectCanvas 362. It may be the final copy of the design to be consumed by the developer or designer in his subsequent implementation, e.g., it may be the agnostic code stored in the LPS3.

The MetaModelGenerator 366 may be a mandatory component used by a user to create an agnostic metamodel definition of the design. This is a definition of the design constructed during the model 320 and ready for application code generation and implementation. A source code may be formed via a MetaModelGenerator 366, e.g., assembled by the MetaModelGenerator 366. The source code may be a description of an application code containing the components and functions being called. The source code can be generated automatically from the model prepared by the user via ProjectCanvas 362. The source code can be saved, and the source code can be refreshed when a new exploration of a hardware microservice came into action, e.g., the superset was updated.

FIG. 6c shows an example of a deploying process 330 (deploy), especially a source code provisioning. For example, a capability to provision a (software) source code (e.g., an agnostic code) into an IDE application coding space can be provided. The source code may be used by the universal IDE to build an application code. The application code can be in various languages depending on a purpose of a user. Further, the application code can be portable into different environments. For example, the application code can be Java, C++, Android, Swift, etc.

The building of the application code may be done by an ApplicationCodeBuilder 372, which may be a mandatory component of the model by interpreting lines of the source code into series of sequential and parallel processes in the application code. The ApplicationCodeBuilder 372 may use information provided by methods and/or apparatus to expose a microservice to a software layer 374 as described in [1].

The sequential and parallel processes may contain invocation to function in the external component, hardware microservices and user-defined libraries. For example, a part of the source code can be retrieved since during the model 320 the part of the meta code may be generated.

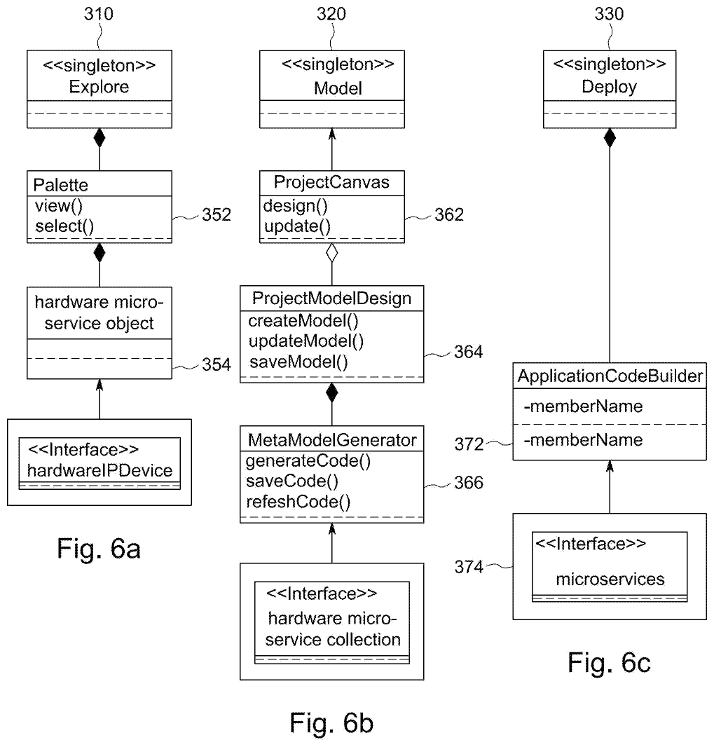

More details and aspects are mentioned in connection with the examples described above and/or below. The example shown in FIG. 6 may comprise one or more optional additional features corresponding to one or more aspects mentioned in connection with the proposed concept or one or more examples described above (e.g., FIGS. 1-5) and/or below (e.g., FIG. 7-9).

FIG. 7 shows an example of a method 700 for a software module. The method comprises receiving 710 information about a superset of a plurality of hardware microservices of the plurality based on the plurality of hardware components and selecting 720 at least one hardware microservice of the plurality of hardware microservices. For example, the method may be performed by a software module as described with reference to FIG. 2.

In an example, the method 700 may further comprise generating a subset comprising the at least one hardware microservice.

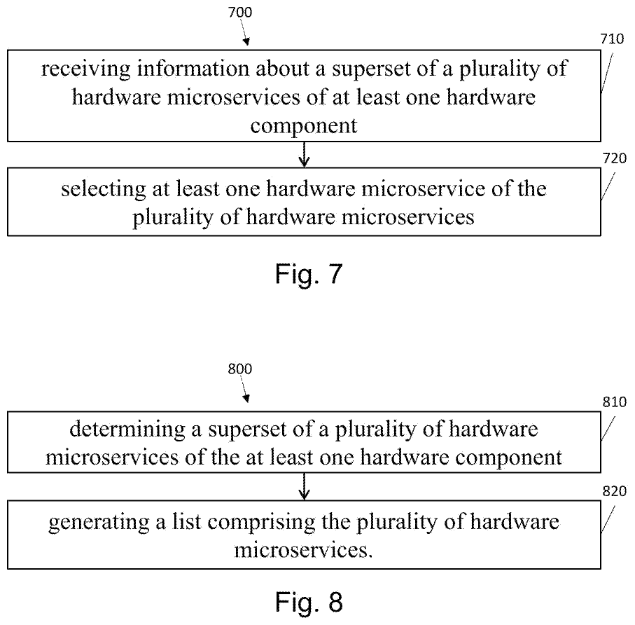

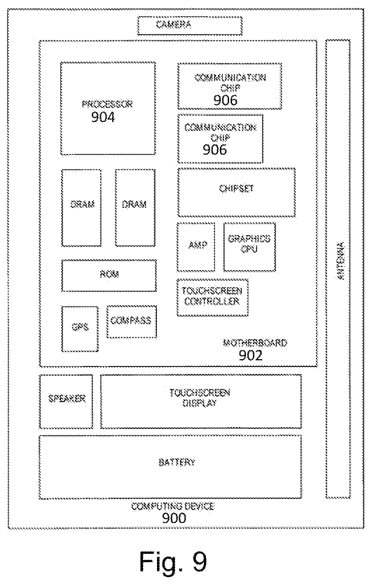

More details and aspects are mentioned in connection with the examples described above and/or below. The example shown in FIG. 7 may comprise one or more optional additional features corresponding to one or more aspects mentioned in connection with the proposed concept or one or more examples described above (e.g., FIGS. 1-6) and/or below (e.g., FIG. 8-9).

FIG. 8 shows an example of a method 800 for a processing unit. The method 800 may comprise determining a superset of a plurality of hardware microservices of the at least one hardware component. For example, the method 800 may be performed by a processing unit as described with reference to FIG. 1.

In an example, the method 800 may further comprise generating a list comprising the plurality of hardware microservices.

More details and aspects are mentioned in connection with the examples described above and/or below. The example shown in FIG. 8 may comprise one or more optional additional features corresponding to one or more aspects mentioned in connection with the proposed concept or one or more examples described above (e.g., FIGS. 1-7) and/or below (e.g., FIG. 9).

FIG. 9 shows a computing device 900. The computing device 900 houses a board 902. The board 902 may include a number of components, including but not limited to a processor 904 and at least one communication chip 906. A processing unit as described above (e.g., with reference to FIG. 1) or a software module as described above (e.g., with reference to FIG. 2) may be comprised by the processor 904 as shown in FIG. 9.

The processor 904 is physically and electrically coupled to the board 902. In some examples the at least one communication chip 906 is also physically and electrically coupled to the board 902. In further examples, the communication chip 906 is part of the processor 904.

Depending on its applications, computing device 900 may include other components that may or may not be physically and electrically coupled to the board 902. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 906 enables wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some examples they might not. The communication chip 906 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 900 may include a plurality of communication chips 906. For instance, a first communication chip 906 may be dedicated to shorter range wireless communications such as Wi-Fi and Bluetooth and a second communication chip 906 may be dedicated to longer range wireless communications such as GPS, EDGE, GPRS, CDMA, WiMAX, LTE, Ev-DO, and others.

The processor 904 of the computing device 900 includes an integrated circuit die packaged within the processor 904. In some examples, the integrated circuit die of the processor includes one or more devices that are assembled in an ePLB or eWLB based POP package that that includes a mold layer directly contacting a substrate, in accordance with examples. The term “processor” may refer to any device or portion of a device that processes electronic data from registers and/or memory to transform that electronic data into other electronic data that may be stored in registers and/or memory.

The communication chip 906 also includes an integrated circuit die packaged within the communication chip 906. In accordance with another example, the integrated circuit die of the communication chip includes one or more devices that are assembled in an ePLB or eWLB based POP package that that includes a mold layer directly contacting a substrate, in accordance with examples.

More details and aspects are mentioned in connection with the examples described above. The example shown in FIG. 8 may comprise one or more optional additional features corresponding to one or more aspects mentioned in connection with the proposed concept or one or more examples described above (e.g., FIG. 1-8).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed embodiments, alone and in various combinations and sub combinations with one another. The disclosed methods, apparatuses, and systems are not limited to any specific aspect or feature or combination thereof, nor do the disclosed embodiments require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rear-ranged or performed concurrently. Moreover, for the sake of simplicity, the attached figures may not show the various ways in which the disclosed methods can be used in conjunction with other methods.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

An example (e.g., example 1) relates to a processing unit, comprising one or more interfaces configured to communicate with at least one hardware component and processing circuitry configured to control the one or more interfaces and to determine a superset of a plurality of hardware microservices of the at least one hardware component.

Another example (e.g., example 2) relates to a previously described example (e.g., example 1) wherein the processing circuitry is further configured to generate a list comprising the plurality of hardware microservices.

Another example (e.g., example 3) relates to a previously described example (e.g., one of the examples 1-2) wherein the processing circuitry is further configured to observe a status of the at least one hardware component and if the status of the at least one hardware component has changed redetermine a hardware microservice of the at least one hardware component.

An example (e.g., example 4) relates to a software module, comprising one or more interfaces configured to communicate with a processing unit and processing circuitry configured to control the one or more interfaces and to receive information about a superset of a plurality of hardware microservices of at least one hardware component, provide information about the superset and generate a subset based on a user input.

Another example (e.g., example 5) relates to a previously described example (e.g., the example 4) wherein provide information about the superset and generate a subset is comprised by an exploring process.

Another example (e.g., example 6) relates to a previously described example (e.g., one of the examples 4-5) wherein the processing circuitry is further configured to check if an update of the received information is available and if the received information has been updated receive updated information about the plurality of hardware microservices.

Another example (e.g., example 7) relates to a previously described example (e.g., one of the examples 4-6) wherein the processing circuitry is further configured to synchronize the plurality of hardware microservices to provide them to an external processing unit.

Another example (e.g., example 8) relates to a previously described example (e.g., one of the examples 4-7) wherein if a plurality of hardware microservice of the plurality of hardware microservices is selected the processing circuitry is further configured to generate a query plan for the plurality of hardware microservice.

Another example (e.g., example 9) relates to a previously described example (e.g., the example 8) wherein the processing circuitry is further configured to render the query plan of the plurality of hardware microservices into a hierarchical tree.

Another example (e.g., example 10) relates to a previously described example (e.g., one of the examples 4-9) wherein the processing circuitry is further configured to generate a sequence flow of the subset.

Another example (e.g., example 11) relates to a previously described example (e.g., the example 10) wherein generate the sequence flow is comprised by a modeling process.

Another example (e.g., example 12) relates to a previously described example (e.g., one of the examples 10-11) wherein the processing circuitry is further configured to check if an output parameter of a first hardware microservice of the plurality of hardware microservices in the sequence flow matches an input parameter of a second hardware microservice of the plurality of hardware microservices in the sequence flow.

Another example (e.g., example 13) relates to a previously described example (e.g., one of the examples 10-12) wherein the processing circuitry is further configured to generate an agnostic code from the sequence flow.

Another example (e.g., example 14) relates to a previously described example (e.g., the example 13) wherein the processing circuitry is further configured to transmit the agnostic code to an external processing unit to enable the external processing to use the plurality of hardware microservices.

Another example (e.g., example 15) relates to a previously described example (e.g., one of the examples 10-14) wherein the processing circuitry is further configured to decode the agnostic code to a native-code type.

Another example (e.g., example 16) relates to a previously described example (e.g., the examples 15) wherein decode the agnostic code is comprised by a deploying process.

An example (e.g., example 17) relates to a method, receiving information about a superset of a plurality of hardware microservices of at least one hardware component and selecting at least one hardware microservice of the plurality of hardware microservices.

Another example (e.g., example 18) relates to a previously described example (e.g., the example 17) further comprising generating a subset comprising the at least one hardware microservice.

Another example (e.g., example 19) relates to a previously described example (e.g., one of the examples 17-18) further comprising checking if an update of the received information is available and if the received information has been updated receiving updated information about the plurality of hardware microservices.

Another example (e.g., example 21) relates to a previously described example (e.g., one of the examples 17-20) further comprising if a plurality of hardware microservice of the plurality of hardware microservices is selected generating a query plan for the plurality of hardware microservice.

Another example (e.g., example 22) relates to a previously described example (e.g., the example 21) further comprising rendering the query plan of the plurality of hardware microservices into a hierarchical tree.

An example (e.g., example 23) relates to a non-transitory, computer-readable medium comprising a program code that, when the program code is executed on a computer, a processor, or a programmable hardware component, performs one of the above examples (e.g., the example 17-21).

An example (e.g., example 23a) relates to a computer program having a program code for performing the method of the above examples (e.g., one of the examples 17-21), when the computer program is executed on a computer, a processor, or a programmable hardware component.

An example (e.g., example 24) relates to a method comprising determining a superset of a plurality of hardware microservices of the at least one hardware component.

Another example (e.g., example 25) relates to a previously described example (e.g., the example 24) further comprising generating a list comprising the plurality of hardware microservices.

An example (e.g., example 26) relates to a non-transitory, computer-readable medium comprising a program code that, when the program code is executed on a computer, a processor, or a programmable hardware component, performs one of the above examples (e.g., according to one of the examples 24-25).

An example (e.g., example 26a) relates to a computer program having a program code for performing the method of the above examples (e.g., one of the examples 24-25), when the computer program is executed on a computer, a processor, or a programmable hardware component.

An example (e.g., example 27) relates to a processing unit, comprising means for processing and means for storing information, wherein the processing unit is configured to determine a superset of a plurality of hardware microservices of the at least one hardware component.

An example (e.g., example 28) relates to a software module, comprising means for processing and means for storing information, wherein the software module is configured to receive information about a superset of a plurality of hardware microservices of at least one hardware component, provide information about the superset and generate a subset based on a user input.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. Processing unit, comprising:
one or more interfaces configured to communicate with at least one hardware component; and
processing circuitry configured to control the one or more interfaces and to:
determine a superset of a plurality of hardware microservices of the at least one hardware component.

2. The processing unit according to claim 1, wherein
the processing circuitry is further configured to generate a list comprising the plurality of hardware microservices.

3. The processing unit according to claim 1, wherein
the processing circuitry is further configured to:
observe a status of the at least one hardware component; and
if the status of the at least one hardware component has changed redetermine a hardware microservice of the at least one hardware component.

4. A software module, comprising:
one or more interfaces configured to communicate with a processing unit; and
processing circuitry configured to control the one or more interfaces and to:
receive information about a superset of a plurality of hardware microservices of at least one hardware component;
provide information about the superset; and
generate a subset based on a user input.

5. The software according to claim 4, wherein
provide information about the superset and generate a subset is comprised by an exploring process.

6. The software module according to claim 4, wherein
the processing circuitry is further configured to:
check if an update of the received information is available; and
if the received information has been updated receive updated information about the plurality of hardware microservices.

7. The software module according to claim 4, wherein
the processing circuitry is further configured to synchronize the plurality of hardware microservices to provide them to an external processing unit.

8. The software module according to claim 4, wherein
if a plurality of hardware microservice of the plurality of hardware microservices is selected the processing circuitry is further configured to generate a query plan for the plurality of hardware microservice.

9. The software module according to claim 8, wherein
the processing circuitry is further configured to render the query plan of the plurality of hardware microservices into a hierarchical tree.

10. The software module according to claim 4, wherein
the processing circuitry is further configured to generate a sequence flow of the subset.

11. The software module according to claim 10, wherein
generate the sequence flow is comprised by a modeling process.

12. The software module according to claim 10, wherein
the processing circuitry is further configured to check if an output parameter of a first hardware microservice of the plurality of hardware microservices in the sequence flow matches an input parameter of a second hardware microservice of the plurality of hardware microservices in the sequence flow.

13. The software module according to claim 10, wherein
the processing circuitry is further configured to generate an agnostic code from the sequence flow.

14. The software module according to claim 13, wherein
the processing circuitry is further configured to transmit the agnostic code to an external processing unit to enable the external processing to use the plurality of hardware microservices.

15. The software module according to claim 10, wherein
the processing circuitry is further configured to decode the agnostic code to a native-code type.

16. The software module according to claim 15, wherein
decode the agnostic code is comprised by a deploying process.

17. A method, comprising:
receiving information about a superset of a plurality of hardware microservices of at least one hardware component; and
selecting at least one hardware microservice of the plurality of hardware microservices.

18. The method according to claim 17, further comprising,
generating a subset comprising the at least one hardware microservice.

19. The method according to claim 17, further comprising
checking if an update of the received information is available; and
if the received information has been updated receiving updated information about the plurality of hardware microservices.

20. The method according to claim 17, further comprising
synchronizing the plurality of hardware microservices to provide them to an external processing unit.

21. The method according to claim 17, further comprising
if a plurality of hardware microservice of the plurality of hardware microservices is selected generating a query plan for the plurality of hardware microservice.

22. The method according to claim 21, further comprising
rendering the query plan of the plurality of hardware microservices into a hierarchical tree.

23. A non-transitory, computer-readable medium comprising a program code that, when the program code is executed on a computer, a processor, or a programmable hardware component, performs receiving information about a superset of a plurality of hardware microservices of the at least one hardware component and selecting at least one hardware microservice of the plurality of hardware microservices.
